(19) United States
(12) Patent Application Publication
(10) Pub. No.: US 2013/0080541 A1
(43) Pub. Date: Mar. 28, 2013

(54) Peer-Based Messaging Systems and Methods

(71) Applicant: Gordon Bruce Herbert, San Diego, CA (US)

(72) Inventor: Gordon Bruce Herbert, San Diego, CA (US)

(73) Assignee: BULLETIN.NET INC., Sarasota, FL (US)

(21) Appl. No.: 13/241,221

(22) Filed: Sep. 23, 2011

(51) Int. Cl. G06F 15/16

(52) U.S. Cl. 709/206

(57) ABSTRACT

Peer-based messaging systems and methods are provided. In one embodiment, a method for transmitting electronic messages may include receiving an electronic message, originated at a first communication device, over a first protocol. The electronic message is received at a second communication device. The method may also include converting, at the second communication device, the electronic message to a second protocol. The first protocol is different from the second protocol. The method may also include sending the electronic message to a third communication device over the second protocol.

### TECHNICAL FIELD

The illustrative embodiments relate generally to messaging systems and methods, and more particularly, to peer-based messaging systems and methods.

### BACKGROUND

Electronic messages, including, but not limited to, Short Message Service (SMS) or text messages and Multimedia Message Service (MMS) messages, have gained wide popularity as an alternative or a complement to more-traditional voice calls or messages. With this increased popularity, the associated challenge of effectively distributing or managing such electronic messages across a network of communication devices has arisen. This challenge may be exacerbated in networks that contain massive data volume or a large number of communication devices. Current messaging systems may fail to effectively utilize peer communication devices within a network to deliver electronic messages to a destination communication device, including replies therefrom. Further, some current messaging systems may fail to offer analytical, load balancing, or other tools or features to increase the effectiveness or comprehensiveness of their messaging systems.

### SUMMARY

According to an illustrative embodiment, a method for transmitting electronic messages may include receiving an electronic message, originated at a first communication device, over a first protocol. The electronic message is received at a second communication device. The method may also include converting, at the second communication device, the electronic message to a second protocol. The first protocol is different from the second protocol. The method may also include sending the electronic message to a third communication device over the second protocol.

According to another illustrative embodiment, a method for transmitting electronic messages may include receiving an electronic message from an origination communication device over a first protocol. The electronic message is addressed to a destination communication device. The method may also include searching for a peer communication device within a proximity of the destination communication device, and sending the electronic message to the peer communication device over the first protocol in response to identifying the peer communication device within the proximity of the destination communication device.

According to another illustrative embodiment, a peer-based messaging system includes an electronic message management application executable on a peer communication device. The electronic message management application receives electronic messages, originated at one or more origination communication devices, over an internet-based protocol, converts the electronic messages to a short message service (SMS) carrier protocol, and sends the electronic messages to one or more destination communication devices over the SMS carrier protocol.

According to another illustrative embodiment, a peer-based messaging system includes a destination communication device, and an origination communication device to originate an electronic message. The electronic message includes a destination address, in a first format, associated with the destination communication device, and a reply address, in a second format, associated with the origination communication device. The peer-based messaging system includes one or more devices including a pool of peer communication devices. Each peer communication device of the pool of peer communication devices includes an electronic message management application. The one or more devices may (a) receive the electronic message from the origination communication device over a first protocol, (b) create a temporary reply address, in the first format, associated with the reply address of the electronic message, (c) modify the electronic message to form a modified electronic message, the modified electronic message including as a reply address the temporary reply address, (d) forward the modified electronic message to the destination communication device over a second protocol, the second protocol different from the first protocol, (e) receive from the destination communication device, via the second protocol, a reply electronic message including the temporary reply address, and (f) forward the reply electronic message to the origination communication device whose reply address is associated with the temporary reply address.

According to another illustrative embodiment, a method for transmitting electronic messages includes originating an electronic message at an origination communication device. The electronic message includes a destination address, in a first format, associated with a destination communication device, and a reply address, in a second format, associated with an origination communication device. The method includes creating a temporary reply address, in the first format, associated with the reply address of the electronic message, and modifying the electronic message to form a modified electronic message. The modified electronic message includes as a reply address the temporary reply address. The method includes forwarding, from a peer communication device, the modified electronic message to the destination communication device over a carrier protocol, and receiving from the destination communication device via the carrier protocol a reply electronic message comprising the temporary reply address. The reply electronic message is received by the peer communication device. The method includes forwarding, from the communication device, the reply electronic message to the reply address associated with the temporary reply address.

### BRIEF DESCRIPTION OF THE DRAWINGS

FIG. 1 is a schematic, pictorial representation of a peer-based messaging system according to an illustrative embodiment;

FIG. 2 is a diagran showing an interaction between the elements of FIG. 1 according to an illustrative embodiment;

FIG. 3 is a schematic, block diagran of a peer-based messaging system according to an illustrative embodiment;

FIG. 4 is a schematic, pictorial representation of a peer-based messaging system that includes a pool of peer communication devices according to an illustrative embodiment;

FIG. 5 is a flowchart of a process for transmitting an electronic message executable by an electronic message management application on a peer communication device according to an illustrative embodiment;

FIG. 6 is a flowchart of a process for transmitting an electronic message executable by an electronic message management application on a peer communication device according to another illustrative embodiment;

FIG. 7 is a flowchart of a process for transmitting an electronic message executable by a registration server according to an illustrative embodiment;

FIG. 8 is a flowchart of a process for transmitting an electronic message executable by a registration server according to another illustrative embodiment;

FIG. 9 is a flowchart of a process for transmitting an electronic message in a peer-based messaging system according to another illustrative embodiment; and

FIG. 10 is a schematic, block diagran of a data processing system in which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled, in the art to practice the embodiments described herein, the description may omit certain information known to those skilled in the art. The following detailed description is, therefore, not to be taken in a limiting sense, and the scope of the illustrative embodiments are defined only by the appended claims.

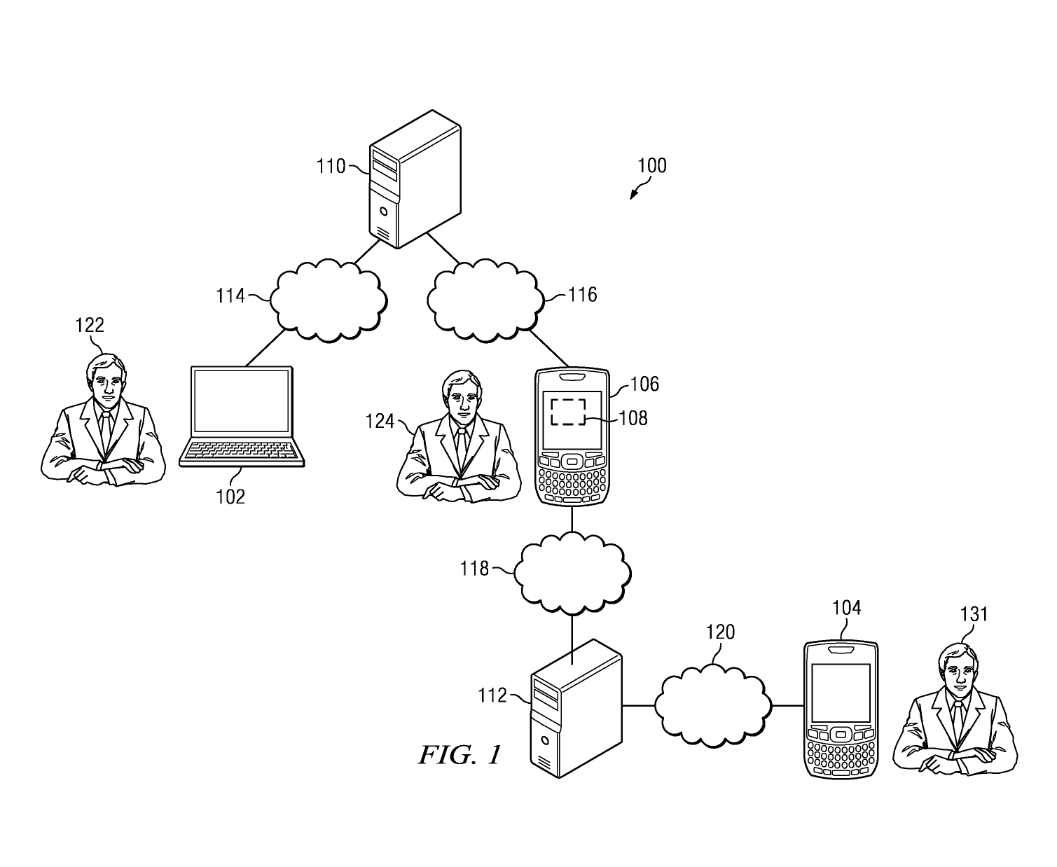

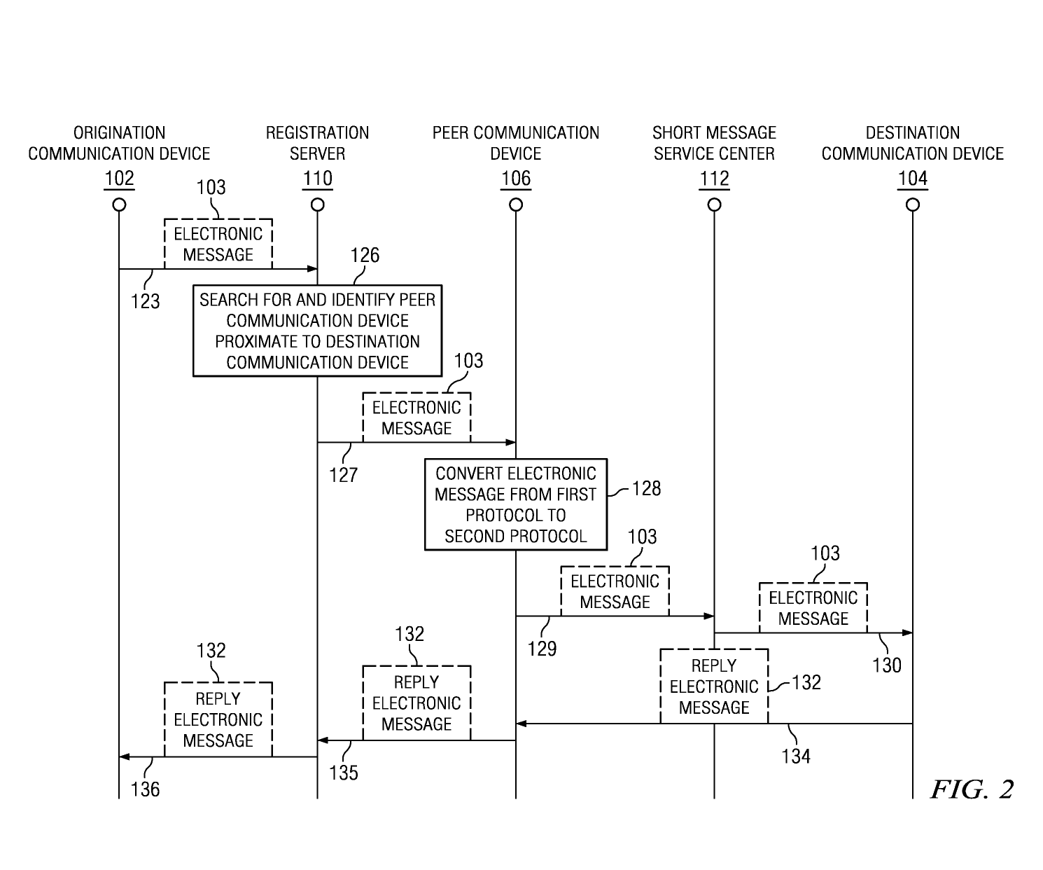

Referring to FIGS. 1 and 2, an illustrative embodiment of a peer-based messaging system 100 includes an origination communication device 102 and a destination communication device 104, between which electronic messages may be transmitted or exchanged using an intermediate or peer communication device 106. Unless otherwise indicated, as used herein, “or” does not require mutual exclusivity. The peer communication device 106 also includes an electronic message management application 108 that facilitates the transfer of electronic messages between the origination communication device 102 and the destination communication device 104. As will be described in further detail below, the electronic message management application 108 may include a number of enhancing features (e.g., housekeeping and security features) for use within the peer-based messaging system 100.

The peer-based messaging system 100 may also include one or more registration servers 110. The registration server 110 may be in data communication with the origination communication device 102 and the peer communication device 106. In one embodiment, the registration server 110 may be Internet visible, and messages to and from the registration server 110 may be conducted over standard computer network connections, such as the Internet. In addition, an HTML interface may exist for the registration server 110 for use by, e.g., the user 122 or any other user in the peer-based messaging system 100, and the HTML interface may provide for geographic tracking of peer communication devices, grouping functionality (explained below), reporting, or other functions. In one non-limiting example, the registration server 110 may be a publicly-available registration server. In one embodiment, the electronic message 103 is a short message service (SMS) message, and the peer-based messaging system 100 includes a short message service center (SMSC) 112 in data communication with the peer communication device 106 and the destination communication device 104,

In one embodiment, electronic messages, such as the electronic message 103, are transmitted within the peer-based messaging system 100 over two or more protocols. Numerous combinations of protocols are possible in the illustrative embodiments. For example, the data communication medium 114 between the origination communication device 102 and the registration server 110 may utilize an Internet-based protocol, such as a Transmission Control Protocol/Internet Protocol (TCP/IP) (e.g., TCP/IP Layer 7 protocol). Likewise, the data communication medium 116 between the registration server 110 and the peer communication device 106 may use an Internet-based protocol (e.g., TCP/IP Layer 7 protocol).

The data communication medium 118 between the peer communication device 106 and the short message service center 112 may use a different protocol than the Internet-based protocol used by the data communication media 114, 116. For example, data communication medium 118 may use a carrier protocol. Likewise, the data communication medium 120 between the short message service center 112 and the destination communication device 104 may use a carrier protocol. In an embodiment in which the electronic message 103 is an SMS message, the carrier protocols employed by the data communication media 118, 120 are protocols usable for the transmission of SMS messages (e.g., networks voice channel (SSI), WCDMA, GPRS, 3G, 4G, WiFi, a transport layer, etc.) Thus, in one embodiment, the user 122 of the origination communication device 102 may send an electronic message 103 from the origination communication device 102 to the peer communication device 106 via the registration server 110 over an Internet-based protocol. The electronic message 103 may then be sent from the peer communication device 106 to the destination communication device 104 via the short message service center 112 using a carrier protocol able to transmit SMS messages.

In one embodiment, the user 124 of the peer communication device 106 may download the electronic message management application 108 onto his or her peer communication device 106. The electronic message

management application 108 may then register the user 124 with the registration server 110. Anytime after downloading the electronic message management application 108, including during registration, the user 124 may input a set of user settings customizing the electronic message management application 108 for the user 124; such user settings will be described in further detail below. As used herein, including in the claims, the term “set” may encompass a quantity of one or more. In one embodiment, after registration, the peer communication device 106 may relay electronic messages sent from, the registration server 110 via the Internet-based protocol of the data communication medium 116 out to a carrier short message service center 112.

An illustrative embodiment of the transmission of electronic messages within the peer-based messaging system 100 after the user 124 has downloaded the electronic message management application 108 onto the peer communication device 106 is shown in FIG. 2. In the example of FIG. 2, the user 122 may interface with the origination communication device 102 to prepare and/or send the electronic message 103. In one embodiment, the electronic message 103 may be sent using an Internet-based or HTML interface with the registration server 110. The registration server 110 receives the electronic message 103 from the origination communication device 102 over a first protocol (data communication 123). The electronic message 103 may be addressed to the destination communication device 104. The registration server 110 may then search for and identify the peer communication device 106 proximate to the destination communication device 104 (process 126). As used herein, the term “proximate” may be any user-definable or pre-definable distance, region, area, radius, grid, association, etc. that is associated with the location of the destination communication device 104. By way of non-limiting example, the peer communication device 106 may be considered proximate to the destination communication device 104 if the peer communication device 106 is “on-net” and/or is registered to the same network as the destination communication device 104.

Upon identifying the peer communication device 106, the registration server 110 may send the electronic message 103 to the peer communication device 106 over the first protocol (data communication 127). After receiving the electronic message 103, which was originated at the origination communication device 102, over the first protocol, the peer communication device 106 may convert the electronic message 103 to a second protocol (process 128). The second protocol may be different from the first protocol. For example, the first protocol may be an Internet-based protocol, such as TCP/IP, and the second protocol may be a carrier protocol that is able to transmit SMS or Multimedia Message Service (MMS) messages. It will be appreciated that the conversion of the electronic message 103 from the first protocol to the second protocol does not necessarily imply a change in the electronic message itself, but may comprise simply changing the protocol by which the electronic message 128 is sent. Therefore, in one embodiment, the electronic message 128 may remain unchanged during the conversion process, yet be transmitted over different protocols to and from the peer communication device 106, respectively, due to the conversion process.

Upon receiving the electronic message 103, the peer communication device 106 may refrain from notifying the user 124 of the peer communication device 106 since electronic message 103 is addressed and intended for delivery to the destination communication device 104. In particular, the electronic message management application 108 on the peer communication device 106 may hide the electronic message 103 from viewing by the user 124 of the peer communication device 106.

The peer communication device 106 may then send the electronic message 103 to the short message service center 112 over the second protocol (data communication 129). The short message service center 112 may then relay the electronic message 103 to the destination communication device 104 over the second protocol (data communication 130). Upon receipt of the electronic message 103, the destination communication device 104 may notify the user 131 of the destination communication device 104 that the electronic message 103 has been received.

After receiving the electronic message 103, the user 131 of the destination communication device 104 may choose to send a reply to the user 122 of the origination communication device 102. For example, if the electronic message 103 received by the user 131 is an SMS message, the user 131 may choose to reply back to the user 122 of the origination communication device 102 with an SMS message. The reply electronic message 132, which may be responsive to the electronic message 103 and be addressed to the origination communication device 102, may be routed back to the origination communication device 102 via the peer communication device 106. An addressing scheme that allows both the electronic message 103 and the reply electronic message 132 to be routed between the origination communication device 102 and the destination communication device 104 via the peer communication device 106 may be used, including, but not limited to, an addressing scheme disclosed in U.S. Pat. No. 6,134,432, which is hereby incorporated by reference in its entirety.

In one embodiment, the destination communication device 104, responsive to input from the user 131, may send the reply electronic message 132 to the peer communication device 106. The reply electronic message 132 may be routed via the short message service center 112, or directly from the destination communication device 104 to the peer communication device 106. Also, the transmission of the reply electronic message 132 from the destination communication device 104 to the peer communication device 106 may be over the second protocol (data communication 134). For example, in the embodiment in which the reply electronic message 132 is an SMS message, the SMS message may be transmitted over a carrier protocol able to transmit SMS messages. In one embodiment, the electronic message management application 108 may ensure that replies, such as replies via SMS, are hidden from the user 124 of the peer communication device 106.

The peer communication device 106 may then send the reply electronic message 132 to the registration server 110 over the first protocol (data communication 135). The registration server 110 may then relay the reply electronic message 132 to the origination communication device 102 over the first protocol (data communication 136).

By way of a specific and non-limiting example, the registration server 110 may require the electronic message 103 to be sent to the destination communication device 104 that is located in Canada. The peer communication device 106 within Canada running the electronic message management application 108 may be searched for, identified, and/or contacted via an Internet-based protocol and the electronic message management application 108 may handle the dispatch of the electronic message 103 to the destination communication device 104. A reply to this electronic message 103 (e.g., reply electronic message 132) may also be processed by the electronic message management application 108, sent to the registration server 110 using the Internet-based protocol, and ultimately terminate at the origination communication device 102.

It will be appreciated that the terms “origination”, “peer”, and “destination” used to describe the communication devices 102, 106, 104, respectively, are for illustration purposes only, and that messages may be transmitted amongst these communication devices in any direction and any combination while still utilizing the features of the illustrative embodiments. For example, the origination communication device 102 and the peer communication device 106 may be interchanged such that the peer communication device 106 sends an electronic message to the destination communication device 104 via the origination communication device 102; in this case, the origination communication device 102 may be loaded with the electronic message management application 108. It will also be appreciated that, although three communication devices 102, 104, 106 are shown, in FIGS. 1 and 2, any number of communication devices may be included in the peer-based messaging system 100. For example, in a large-scale network, the peer-based messaging system 100 may include dozens, hundreds, thousands, millions, etc. communication devices with which to perform the processes and peer-based communication disclosed herein.

In one embodiment, segregated peer-based messaging systems may be implemented so as to provide for a grouping-functionality. The grouping functionality may provide the ability for users, companies, or other entities to create their own private, segregated implementation of the illustrative embodiments.

The electronic message 103, including any replies thereto, may be any type of electronic message capable of being communicated between devices. For example, the electronic message 103 may be an e-mail, an SMS message, an MMS message, a text or text-based message, an instant message (IM), etc.

Each of the communication devices 102, 104, 106 may be any device, mobile or otherwise, capable of communicating with other devices. For example, each of the communication devices 102, 104, 106 may be a computer (e.g., a laptop, netbook, tablet computer, desktop computer, or minicomputer), a cellular phone (e.g., a smart phone), a personal digital assistant, a kiosk, a portable gaming device, a web browsing device, a media player, or any other electronic device capable of communicating data. Also, the communication devices 102, 104, 106 may differ from one another.

The techniques, technologies, or media by which the components of the peer-based messaging system 100 intercommunicate are numerous. For example, the peer-based messaging system 100, or any portion thereof, may be part of a personal area network (PAN), a local area network (LAN), a campus area network (CAN), a metropolitan area network (MAP), or any other network type. Also, communication between any two of the elements in the peer-based messaging system 100 may be direct or indirect. The data communication media 114, 116, 118, 120 may be any medium through which data can be communicated. For example, the data communication media 114, 116, 118, 120 may include wired or wireless data connections, and may utilize a virtual private network (VPN), multi-protocol label switching (MPLS), the Internet, or any other data communication media. In the case of wireless communications, any wireless standard for communicating data may be utilized, including, but not limited to, CDMA (e.g., cdmaOne or CDMA2000), GSM, 3G, 4G, Edge, an over-the-air network, Bluetooth, etc.

In one example, the peer-based messaging system 100 may utilize the Internet, with any combination of the data communication media 114, 116, 118, 120 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIG. 1 is intended as an example, and not as an architectural limitation for the different illustrative embodiments.

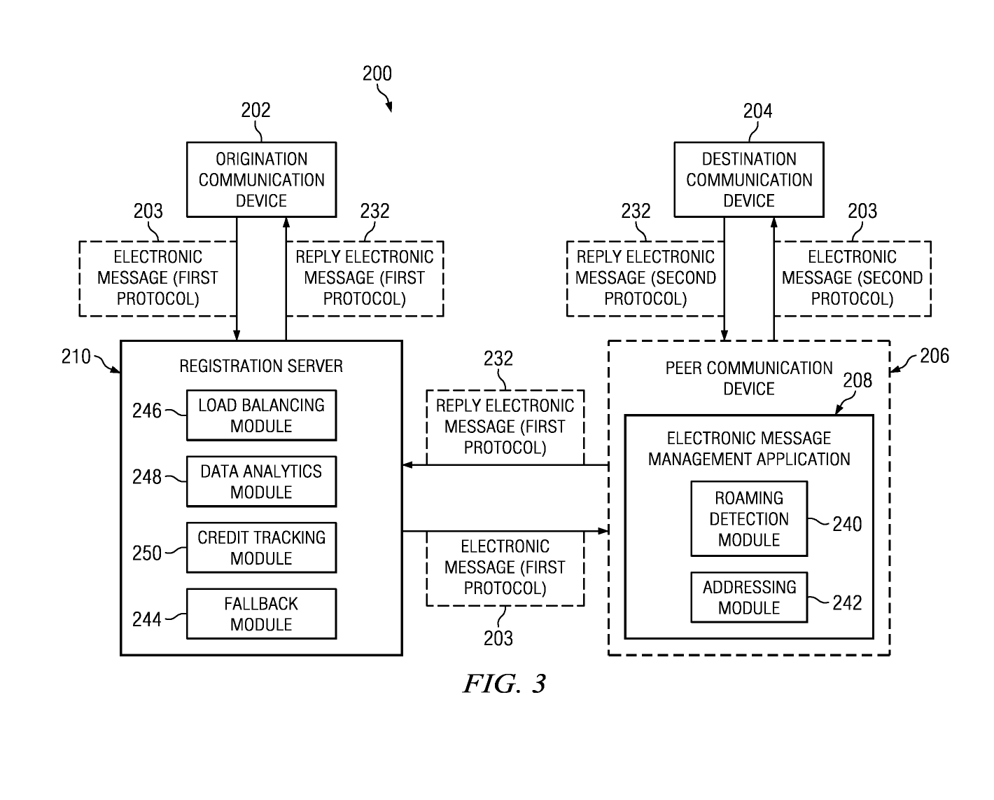

Referring to FIG. 3, an illustrative embodiment of the peer-based messaging system 200 includes the origination communication device 202 sending the electronic message 203 to the destination communication device 204 via the registration server 210 and the peer communication device 206 over two protocols. While not illustrated here, the peer-based messaging system 200 may also include the short message service center described in FIGS. 1 and 2. Elements of FIG. 3 that are analogous to elements in FIGS. 1 and 2 have been shown by indexing the reference numerals by 100. FIG. 3 also illustrates a number of modules and elements within the registration server 210 and the electronic message management application 208, which, in some embodiments, may be used to enhance or complement the peer-based messaging system 200.

In one embodiment, the electronic message management application 208 may include a roaming detection module 240 that may detect whether the peer communication device 206 is in a roaming mode. For example, the roaming detection module 240 may detect whether the peer communication device 206 is outside of the service area of its carrier. Upon detecting that the peer communication device 206 is roaming, the electronic message management application 208 may disable or cease communication between the peer communication device 206 and the registration server 210. Disabling communication between the peer communication device 206 and the registration server 210 may prevent the registration server 210 from identifying the peer communication device 206 as the medium through which to transmit the electronic message 203 to the destination communication device 204, thus helping to ensure that the electronic message 203 is properly transmitted. In one embodiment, the roaming detection module 240 may also communicate to the registration server 210 if the peer communication device 206 roaming, upon which the registration server 210 will remove the peer communication device 206 as a candidate through which to transmit the electronic message 203 to the destination communication device 204. Once the peer communication device 206 is no longer roaming, the roaming detection module 240 may detect such non-roaming status and the electronic message management application 208 may reestablish communication with a registration server 210. Registration server 210 may then consider the peer communication device 206 as a candidate for transmitting the electronic message 203 to the destination communication device 204.

The electronic message management application 208 may also include an addressing module 242. In another embodiment, the addressing module 242 may be included and/or implemented on or at the registration server 210. The addressing module 242 may ensure that the electronic message 203 and a reply electronic message 232 is associated or contains the addressing data required to properly route the electronic message 203 and the reply electronic message 232 to their destinations via the peer communication device 206. For example, when sending the electronic message 203 to the destination communication device 204, the addressing module 242 may associate the electronic message 203 with addressing data such that the reply electronic message 232 will be sent back to the peer communication device 206, which then routes the reply electronic message 232 back to the origination communication device 202. As explained below, the addressing module 242 may utilize a pool of numbers to properly address messages. In one embodiment, each communication device in the peer-based messaging system 200 may be uniquely identified by an MSISDN for the purpose of conversation threading, as disclosed in U.S. Pat. No. 6,134,432, which is incorporated, by reference in its entirety. Reply paths may also be distributed across multiple devices using the illustrative embodiments disclosed in U.S. Pat. No. 6,134,432, thus reducing the probability that a communication device leaving the peer-based messaging system 200 will be unavailable for the purpose of transmitting reply electronic messages. In one embodiment, a mobile device, such as the peer communication device 206, may be an IP-compatible device that utilizes an addressing scheme or structure in U.S. Pat. No. 6,134,432 to provide a messaging bridge from an IP-based protocol or device to a cellular protocol (e.g., MSISDN).

The registration server 210 may also include functionality to complement, enhance, or alter the peer-based messaging system 200. In one embodiment, the registration server 210 includes a fallback module 244. Should a peer communication device, such as the peer communication device 206, be unavailable within the geographic region of the destination communication device 204, the fallback module 244 of the registration server 210 may operate via carrier short message service center connections and calculate, e.g., the lease-cost route to the destination communication device 204. This fallback capability of the fallback module 244 may be aided with neural logic that trains developing processes or algorithms across the peer-based messaging system 200, enhancing efficiencies while maintaining robustness and continuity in the peer-based messaging system 200.

The peer-based messaging system 200 may have numerous peer communication devices, such as the peer communication device 206, through which to transmit electronic messages. In one embodiment, the registration server 210 includes a load balancing module 246 that may balance or determine usage of the multiple peer communication devices based on any combination of factors. For example, the load balancing module 246 may balance usage of peer communication devices to transmit messages based on the electronic message throughput associated with each of the peer communication devices to ensure that a particular peer communication device, such as the peer communication device 206, does not have excessive electronic message (e.g., SMS) throughput or has not become flooded with messages. In another embodiment, the load balancing module 246 may also ensure that the destination communication device 204 does not become flooded with messages. Thus, the load balancing module 246 may help to balance usage amongst peer communication devices available within the peer-based messaging system 200 to ensure that no particular communication device is being overused.

In one embodiment, one way in which the load balancing module 246 may manage the amount of messages being transmitted through the peer communication device 206 is through a message cap setting associated with the electronic message management application 208 on the peer communication device 206. For example, a user of the peer communication device 206, during registration or otherwise, may input a maximum number of messages allowed to be transmitted through the peer communication device 206 to other devices. The maximum number of messages, or message cap, for any particular peer communication device within the peer-based messaging system 200 may also be determined at the registration server 210.

The load balancing module 246 may also factor in data usage amongst the peer communication devices within the peer-based messaging system 200 to determine which peer communication device to use to transmit the electronic message 203. For example, the load balancing module 246 may determine not to select the peer communication device 206 to transmit the electronic message 203 if the peer communication device 206 experiences excessive data usage by doing so. In a similar manner as the message caps described above, the user of the peer communication device 206 may also input a data cap setting into the electronic message management application 208 to manage the amount of data usage incurred to transmit electronic messages to other devices. The load balancing module 246 may then take these data cap settings into account when determining whether to use a particular peer communication device to transmit the electronic message 203.

The load balancing module 246 may also balance usage amongst the peer communication devices in the peer-based messaging system 200 based on the roaming statuses of each of the peer communication devices. For example, if the peer communication device 206 is roaming, the load balancing module 246 may determine not to use that peer communication device 206 to transmit the electronic message 203 to the destination communication device 204. At times, the peer communication device 206 may be unavailable to deliver the electronic message 203 to a region associated with the destination communication device 204. For example, the peer communication device 206 may not be available in the region of the destination communication device 204, or the electronic message management application 208 may be set so as to not deliver messages in a particular region (e.g., a setting not to deliver international SMS messages). Thus, the load balancing module 246 may also take into account the availability of the peer communication devices for delivering electronic messages to the region or proximity associated with the destination communication device 204.

In another embodiment, another factor usable by the load balancing module 246 to balance usage is for the load balancing module 246 to detect and determine the routing cost through the various peer communication devices in the peer-based messaging system 200. For example, the load balancing module 246 may select the peer communication device 206 through which it is cheapest to route the electronic message 203 to the destination communication device 204 based on, e.g., carrier or other charges, fees, or taxes. The load balancing module 246 may also be used to ensure that reply paths are distributed across multiple devices, reducing the probability that a device leaving the peer-based messaging system 200 will be unavailable for reply purposes; this may be implemented using the illustrative embodiments disclosed in U.S. Pat. No. 6,134,432, which is incorporated by reference.

In one embodiment, the load balancing module 246 may utilize neural technology to implement the various processes or factors for balancing usage amongst the peer communication devices in the peer-based messaging system 200. For example, one or more neural algorithms or processes may manage distribution patterns based on historical usage, such as by time, region, volume, etc.; these patterns may then be used to build a management progran for efficiency and robustness of the network. In another embodiment, a fail-safe mechanism may be included the electronic message management application 208 to ensure that load balancing settings therein are unable to be circumvented.

By way of non-limiting and illustrative example of a geographical load balancing process that may be utilized by the load balancing module 246, each of the peer communication devices in the peer-based messaging system 200 may be identified by its respective subscriber number. Upon registration for inclusion within the peer-based messaging system 200, the subscriber may be asked to set an optional message or data cap. The subscriber associated with the electronic message management application 208 may also be asked whether they wish to accept messages for international destinations. Based on this information, the load balancing module 246 may determine which peer communication devices to utilize in the following order: (1) available in the region specified, (2) available to deliver to the region specified (e.g., via international SMS), (3) below any specified data and message caps, and/or (4) have the lowest SMS outbound usage.

In another embodiment, the load balancing module 246 may balance load across peer communication devices within the peer-based messaging system 200 based on the number of SMS messages sent through the peer communication device 206, a number of SMS messages received via the peer communication device 206, data usage to and from the peer communication device 206 (P2P overhead), and/or defined priorities based on a geographic pooling algorithm within the registration server 210.

In one embodiment, the registration server 210 may also include a data analytics module 248 that analyzes the electronic messages 203, 232 routed within the peer-based messaging system 200. The data analytics module 248 may be used, in one embodiment, to derive value from message content by using a variety of language processing processes or algorithms to profile message content. In one example, the data analytics module 248 may include data warehousing and/or analytics capability for all electronic message (e.g., SMS, MMS, etc.) traffic both inbound and outbound. The data analytics module 248 may also utilize pattern analysis.

In one embodiment, the data analytics module 248 may analyze electronic messages routed to the registration server 210 using rule-based weighting based upon incidences of keywords in electronic messages. For example, such an embodiment may break down or sub-divide message content on a word-by-word basis and assign probabilities of occurrence for a particular user. Each keyword may be assigned a likelihood value which is stored and/or adjusted based on existing data Further messages with both similar and dissimilar words may contribute to the stored weighting. Exclusions may also be possible using an exclusion dictionary; for example, “our”, “the”, and “and” may be excluded from the data analysis.

In one embodiment, the data analytics module 248 may utilize conversational threading analysis. The embodiments in U.S. Pat. No. 6,134,432, incorporated by reference, include a description of the matching of sent and received messages to and from computer systems. The data analytics module 248 may utilize conversational threading analysis to gather contextual information based on natural language processing.

By way of non-limiting example, the following conversation may occur between two communication devices in the peer-based messaging system 200:

(Conversation initiation from a first phone number): Hey! What pizza do you fancy tonight, thinking of that Santos place around the corner. Mark.
(Conversation reply from a second phone number): Sounds good, let's get a Hawaiian with extra pineapple! Dave. From the above message chain, the data analytics module 248 may determine that both the sender and recipient use Santos restaurant for pizza and enjoy Hawaiian pizza. The data analytics module 248 may also determine that the first number is associated with Mark and the second phone number is associated with Dave. Depending upon the embodiment, a process or algorithm may be fundamentally applied to the contextualized message contents using conversational threading analysis.

In one embodiment, the data analytics module 248 may analyze data from the electronic messages according to a data analytics participation setting, which may be set by any of the origination communication device 202, the peer communication device 206, or the destination communication device 204. For example, any of the communication devices in the peer-based messaging system 200 may choose one of an opt-out setting, an opt-in setting, or an anonymous opt-in setting. If the user associated with the communication device chooses an opt-out setting, the data analytics module 248 may refrain from analyzing messages associated with that user except where required for the purposes of investigation regarding abuse or compliance with legal responsibilities. If a user chooses an opt-in setting, messages associated with that user may be fully available for analytics by the data analytics module 248. If the user chooses an anonymous opt-in setting, phone numbers and/or system user identification may be removed from the analytics processes of the data analytics module 248, thereby protecting the user's identity or other data. Other types of data analytics participation settings may be set by the users and the communication devices within the peer-based messaging system 200.

In one embodiment, the registration server 210 may also include a credit tracking module 250 to manage the allocation of credits to an account associated with the peer communication device 206 based on electronic messages sent to or through the peer communication device 206. For example, the credit tracking module 250 may track communication to and from the origination communication device 202 and the peer communication device 206, and allocate credits to the account associated with the peer communication device 206 or its user. Such credits may be in any form, such as cash, credits, or other incentives.

In describing the modules above, a number of user settings have been described that may be inputted into the electronic message management application 208, such as data caps, message caps, data analytics participation settings, etc. In one embodiment, such user settings may be sent to the registration server 210 so that they may be implemented by the modules therein.

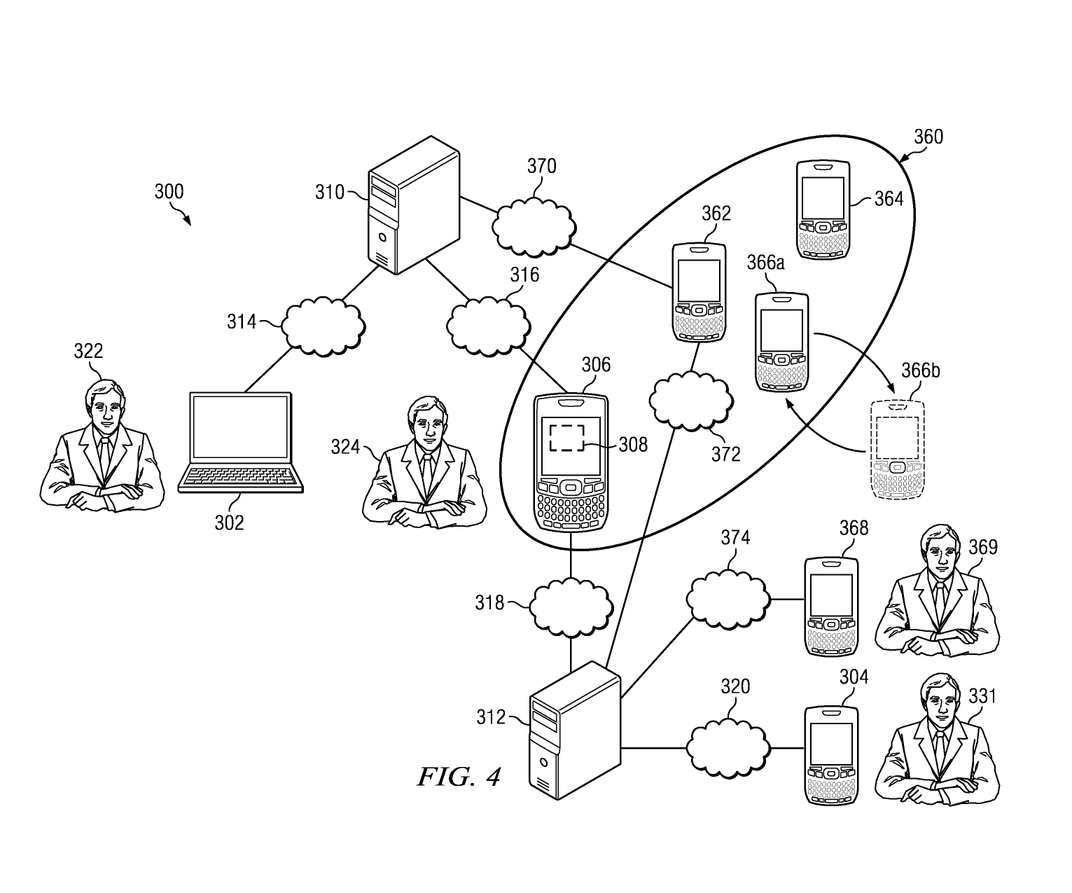

Referring to FIG. 4, an illustrative embodiment of the peer-based messaging system 300 includes a pool 360 of peer communication devices 306, 362, 364, 366 that are each registered to the registration server 310. Elements of FIG. 4 that are analogous to elements in FIGS. 1 and 2 have been shown by indexing the reference numerals by 200. FIG. 4 illustrates the ability of the illustrative embodiments to utilize multiple peer communication devices 306, 362, 364, 366 to transfer electronic messages between origination and destination communication devices 302, 304 within the peer-based messaging system 300. Each of the peer communication devices 306, 362, 364, 366 may have an electronic message management application, such as the electronic message management application 308, installed thereon. Furthermore, the respective users of each of the peer communication devices 306, 362, 364, 366 may use the electronic message management applications installed on their peer communication devices 306, 362, 364, 366 to register with the registration server 310.

The peer communication devices 306, 362, 364, and 366 may be considered to be included in the pool 360, and therefore available to dispatch electronic messages across protocols between the communication devices 302, 304, when the peer communication devices 306, 362, 364, and 366 are not roaming, such as when the peer communication devices 306, 362, 364, and 366 are on a home or carrier network. Any of the peer communication devices 306, 362, 364, or 366 may be removed or excluded from the pool 360 if they are roaming (e.g., on a roaming network) so that the registration server 310 will refrain from using the excluded peer communication device to dispatch an electronic message between communication devices.

The movement of peer communication devices 306, 362, 364, 366 into and out of the pool 360 is exemplified by the peer communication device 366. When the peer communication device 366 registers with the registration server 310 using the electronic message management application deployed thereon, the peer communication device 366 may be added to the pool 360 and be “on-net”, as illustrated by element 366a. If the peer communication device 366 goes into a roaming status, it may be removed from the pool 360 and be “off-net”, as illustrated by element 366b. The peer communication device 366b may thereafter rejoin the pool 360 when it is no longer in a roaming status.

Multiple unique conversation threads, such as the example conversation threads described above, involving or originating from the origination communication device 302 may be maintained or tracked using multiple peer communication devices 306, 362, 364, 366 within the pool 360. For example, in addition to the electronic message conversation thread between the origination communication device 302 and the destination communication device 331, the pool 360 may also maintain a second electronic message conversation thread between the origination communication device 302 and a second destination communication device 368 operated by the user 369. In particular, the peer communication device 362 may be used to maintain the second conversation thread between the origination communication device 302 and the second destination communication device 368; in doing so, the electronic messages, and replies thereto, within the second conversation thread may be communicated via the communication media 370, 372, and 374 across two or more protocols as described in the illustrative embodiments.

The availability of multiple peer communication devices 306, 362, 364, and 366 allows for pools of numbers, such as mobile phone numbers, to be pooled for the purpose of message conversation threading so that multiple conversations may be maintain or tracked within the peer-based messaging system 300. In order to maintain conversation threads in the event that the peer-based messaging system 300 is handling a voluminous amount of messages, a requisite number of peer communication devices, and their associated numbers, may be necessary within the pool 360. This may help to maintain proper transmission of messages within the peer-based messaging system 300. In one embodiment, the illustrative embodiments may pool peer communication devices, and/or their associated numbers, to create message threading ranges through a neural algorithm or process that searches for “on-net” communication devices and removes such communication devices that register on a roaming network; this may allow a single user to have different conversations with the same termination device and allow unique conversation tracking. Further, in one embodiment, if a peer communication device moves “off-net”, then its associated number may be removed from the pool 360 and a new peer communication device that has registered, “on-net” may be added to maintain a required number range as determined by the neural algorithm or process.

Numerous addressing schemes may be available to properly route messages within the peer-based messaging system 300. In one embodiment, the origination communication device 302 may originate an electronic message that, includes a destination address, in a first format, associated with the destination communication device 331. In one example, the first format may correspond to a mobile phone number or an MSISDN number. The electronic message originating from the origination communication device 302 may also include a reply address, in a second format, associated with the origination communication device 302. In one example, the second format may correspond to an Internet address. In this embodiment, the registration server 310 or any of the peer communication devices 306, 362, 364, 366 in the pool 360 (including a single peer communication device), alone or in any combination, may receive the electronic message from the origination communication device 302, create a temporary reply address, in the first format, associated with the reply address of the electronic message, modify the electronic message to form a modified electronic message that includes the temporary reply address as a reply address, and forward the modified electronic message to the destination communication device over a second protocol that is different from the first protocol. The registration server 310 or any combination of the peer communication devices 306, 362, 364, 366 may then receive from the destination communication device 331, via the second protocol, a reply electronic message including the temporary reply address, and forward the reply electronic message to the origination communication device 302 whose reply address is associated with the temporary reply address. In one embodiment, the reply electronic message may be forwarded to the reply address associated with the temporary reply address via the registration server 310. The reply address and the temporary apply address may be associated with one another in a database stored in the registration server 310 or any combination of the peer communication devices 306, 362, 364, 366.

In one embodiment, the peer-based messaging system 300 may route messages both from the origination communication device 302 and/or the Internet to the destination communication device 304, and from the destination communication device 304, back to the origination communication device 302 and/or the Internet again. To accomplish this, the peer-based messaging system 300 may use the concept of addressing schemes. In one example usage, addressing schemes may be used to resolve the inherent differences in the addressing between computer-based mail systems, and mobile phones.

In one embodiment, on a computer mail system (e.g., on a LAN that includes the origination communication device 302), individual users, such as the user 322, may be assigned an identifier (usually their name and home domain) which other clients on the computer mail system can use to send mail to them. Mobile phones, such as the destination communication device 304, however, may in some cases only use numbers to identify other phone users. To simplify sending messages between mail clients, such as the origination communication device 302, and mobile phones, such as the destination communication device 304, the peer-based messaging system 300 may use a number of addressing schemes and methods to determine the recipient.

In one example, electronic messages sent from a computer-based mail system, which may include the origination communication device 302, to a mobile phone

(e.g., destination communication device 304) may require a valid mobile phone number. In another example, a UNIX domain name may be used or required. A valid mobile phone number/domain name address might be 6421200300@sms.domain.com, where the number “6421200300” identifies the destination communication device 304, and “sms.domain.com” identifies the Unix domain name of a gateway, the registration server 310, or any other device in the peer-based messaging system 300.

Electronic messages sent from a mobile phone (e.g., destination communication device 304) to a destination (e.g., LAN or computer mail system that includes the origination communication device 302) may be addressed using a number of different methods. When a message is sent from, an outside e-mail source to a mobile phone, the registration server 310 or any combination of the peer communication devices 306, 362, 364, 366 may create a new, temporary, and unique reply mobile phone or MSISDN number associated with the reply address, before sending the message and the reply mobile phone or MSISDN number to the mobile phone. If the user 331 of the mobile phone replies to this message, the reply mobile phone or MSISDN number may be sent with the reply message back to the registration server 310 or any combination of the peer communication devices 306, 362, 364, 366, which may map back to the e-mail address of the original sender (e.g., origination communication device 302)—for example, either an Internet mail address or some other type of client ID. Thus, the user 331 of the mobile phone may reply to messages without knowing the address of the original sender—the registration server 310 or any combination of the peer communication devices 306, 362, 364, 366 may perform all necessary mapping.

For messages originating from the mobile phone (e.g., destination communication device 304), and not using the reply function, two example methods may be available for determining delivery. If the message is destined for the Internet, the full Internet address of the recipient (e.g., origination communication device 302) may be specified in the body of the message. The mobile phone may then transmit the message to the registration server 310 or any combination of the peer communication devices 306, 362, 364, 366 using a selected Internet mail relay mobile phone number or MSISDN, which may be a special number for Internet mail only. The registration server 310 or any combination of the peer communication devices 306, 362, 364, 366 may be configured such that any message sent to this mobile phone number or MSISDN number will be forwarded to the Internet, and delivered to the recipient address (e.g., the address for the origination communication device 302) specified in the body of the message.

Messages destined for a client of a computer mail system using its server may have two additional addressing options available to them. These options may include two addressing schemes called number map addressing and. number name map addressing. For corporate LAN e-mail systems, number map addressing may use a permanent mobile phone or MSISDN number that is set up for each individual client configured on the system. The system administrator for the system may assign an additional 2 to 4 digit default ID that is tagged onto the permanent mobile phone number or MSISDN when messages are sent. These number ranges may be used to identify the destination client (e.g., origination communication device 302) to receive the message. In one example, only a portion of the overall number may be used—the remainder may be used by the client to identify the individual user within the client mail system. For example, if the Gateway client ID prefix is “642100200”, and the client mail user default ID is “01”, then the full originating address may be “6410020001”—this address is what may be used to reply to messages, and to originate mobile phone-based, messages to the client mail system.

For Internet e-mail and number map addressing, incoming Internet messages may be assigned mobile phone or MSISDN numbers on an ad-hoc basis from a pool of available numbers. This temporary mobile phone or MSISDN number may be stored with the source address of the Internet mail, and may be used if the message is replied to. All numbers in this temporary mobile phone or MSISDN number pool may be reused in oldest first date order. For example, suppose a message comes in from the Internet to a mobile number “6421605600”. It may be addressed as “642160500@sms.bulletin.net” from “anyperson@anothercompany.com”. The registration server 310 or any combination of the peer communication devices 306, 362, 364, 366 may assign a new temporary mobile phone or MSISDN number for the life of the message (e.g., “64210010011234”) and save the originating address with this temporary mobile phone or MSISDN number. When a reply from the mobile phone comes back, the destination address “6421001001234” may be matched to the Internet address of the original message sender. This address (“anyperson@anothercompanycom”) may then be used to transmit the message reply.

In one embodiment, using the number name map addressing scheme with the server of a computer mail system may only require a Gateway client ID prefix to be used when transmitting the message from the mobile phone. This may identify the client (e.g., origination communication device 302) to receive the message. Using an “aliasing facility” in the access server, the client may then use a simple address like John, or 123 in the body of the message to identity the intended recipient. For example, if the gateway client ID prefix is “642100200” and the LAN mail user is “johnsmith”, the message may be received on the mobile phone as from “johnsmith”. Messages sent to the LAN from the mobile phone may be addressed as “TO johnsmith <message body>” and “642100200” entered as the destination phone number, when requested by the phone.

In one embodiment, using the number name map scheme with the Internet may require the mobile phone user 331 to address the Internet-destined message in the body of the message to identity the intended recipient. Once the message is addressed, to the intended recipient, the message may be sent to a predefined, and known mobile phone or MSISDN number. This number may be referred to as a relay number. Messages to this number may be checked by the registration server 310 or any combination of the peer communication devices 306, 362, 364, 366 and the destination address may be obtained from the body of the message. Given that some mobile phones cannot produce the @ character, substitutes like * and $ may be used. As an example, suppose the Gateway Internet mail relay number is “6421900900” and the Internet mail destination is “johnsmith@somecompany.com”. The message may be received from the mobile addressed, to the mobile phone or MSISDN number “6421900900”. The body of the message may contain the address “johnsmith*somecompany.com”.

In one embodiment, the registration server 310 or any combination of the peer communication devices 306, 362, 364, 366 may maintain a large pool of numbers to send messages from. Every time an electronic message is sent, a new address may be selected from the pool and stored, along with the message and destination number, in a database. When the message arrives at the destination communication device 304, the “from” address that appears on the phone may be the number selected from the pool. When the user 331 hits “reply”, the “from” address may be used as the destination. Then, when the registration server 310 or any combination of the peer communication devices 306, 362, 364, 366 receives the reply, the “from” address may be correlated with the outgoing message by looking in our database for the message with a matching pool and destination number. In one embodiment, to ease reply tracking for client applications, client applications may be allowed to pass an ID with each outgoing message. The correlated ID may then be returned to the client with each reply.

By way of non-limiting example, the origination communication device 302 may send a message to phone number “123456” using a chat application. The chat application may assign the message an ID and passes it to the registration server 310. The registration server 310 may assign the message a temporary reply address from its pool of numbers. In one embodiment, this pool of numbers may include a sufficient amount of numbers to maintain numerous conversations originating from the origination communication device 302. The number may be stored in the database along with the destination address, the client's name, and the ID that the chat application assigned. The registration server 310 may then pass the message to the peer communication device 306, which passes the message to the SMSC 312. The SMSC 312 may store the message and forward it to the destination communication device 304. The recipient 331 may reply to the message. Hitting the “reply” button may automatically address the reply electronic message to the sender (e.g., by using the temporary reply address assigned by the registration server 310). The destination communication device 304 may send the reply message to the SMSC 312. The SMSC 312 may forward the reply message to the peer communication device 306, which forwards the reply message to the registration server 310. The SMSC 312 may also pass the source (handset number) and destination (temporary reply address) of the reply message. The registration server 310 may query the database to find the most recent message with a matching handset and pool number. The registration server 310 may retrieve the associated client name and client ID from the database and transmit the reply message, along with the ID, back to the chat application.

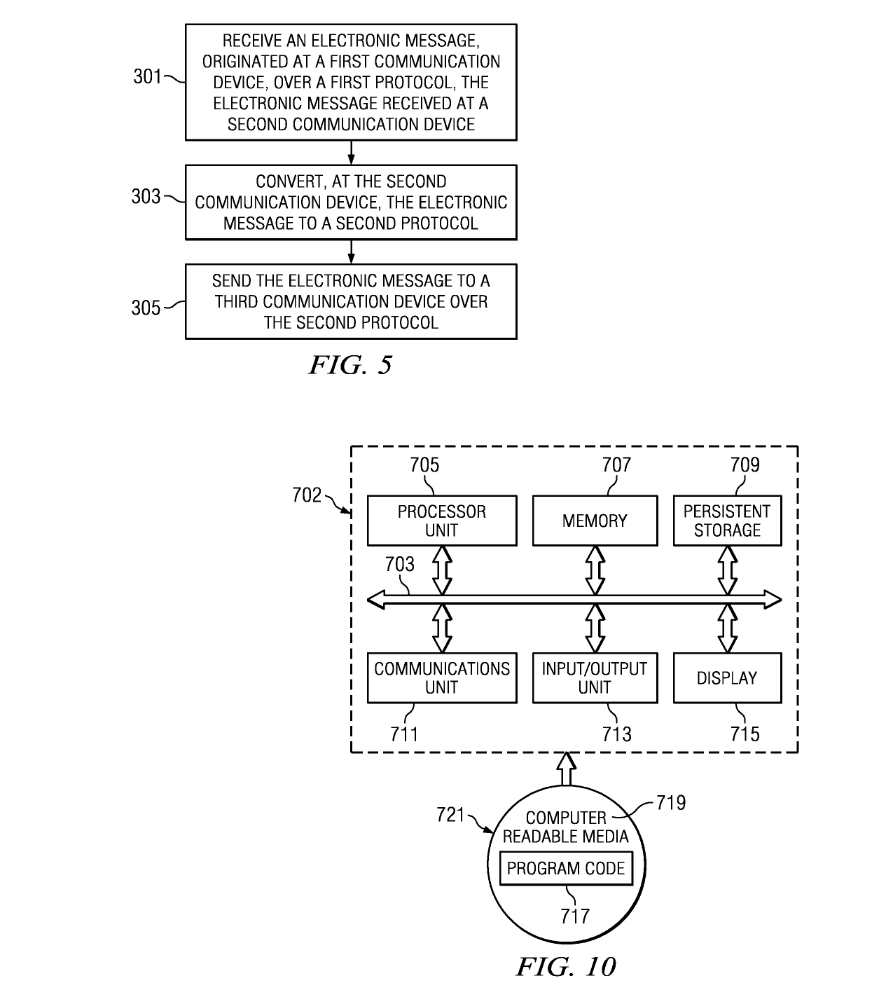

Referring to FIG. 5, an illustrative embodiment of a process for transmitting electronic messages within a peer-based messaging system, which may be implemented, e.g., by an electronic message management application on a peer communication device, includes receiving an electronic message, originated at a first communication device, over a first protocol (step 301). The electronic message may be received at a second communication device. The process may also include converting, at the second communication device, the electronic message to a second protocol (step 303). In one embodiment, the first protocol may differ from the second protocol. For example, if the electronic message is an SMS message, the first protocol may be an Internet-based protocol, and the second protocol may be a carrier protocol usable to transmit SMS messages. The process may also include sending the electronic message to a third communication device over the second protocol (step 305).

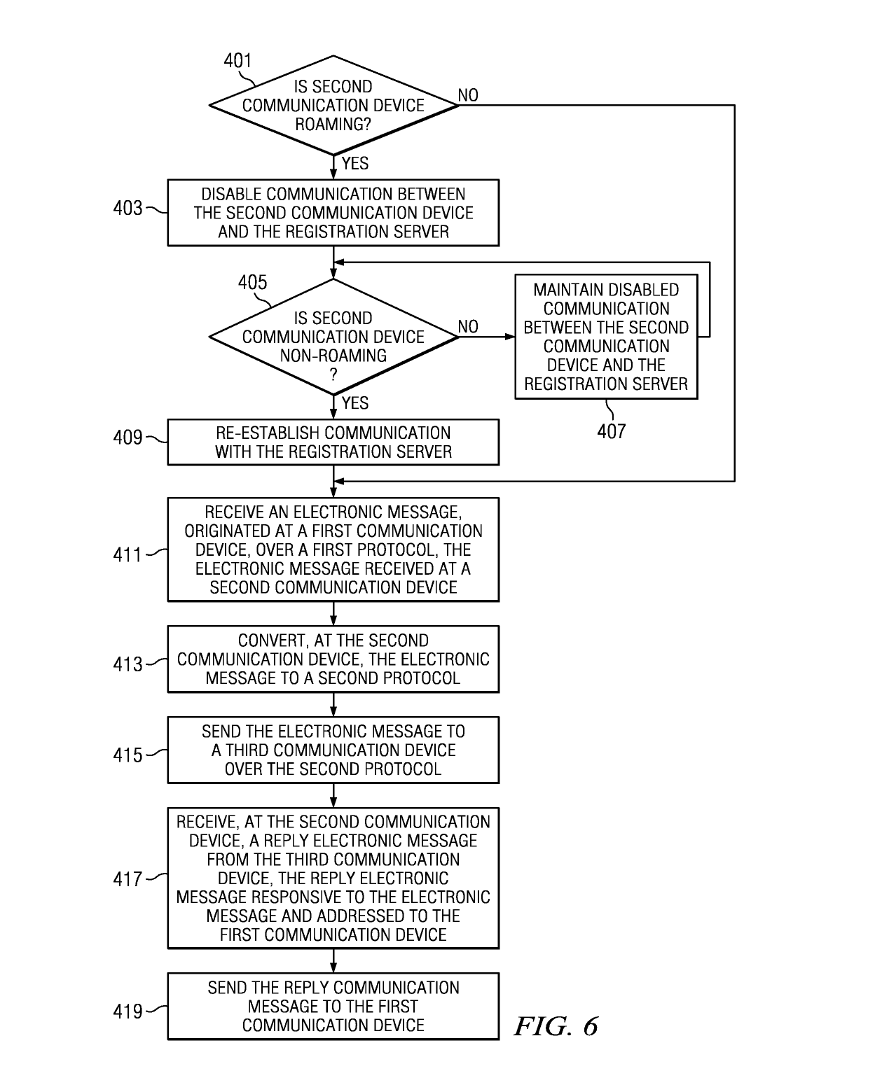

Referring to FIG. 6, an illustrative embodiment of a process for transmitting electronic messages in a peer-based messaging system, which may be implemented by, e.g., an electronic message management application on a peer communication device, may include determining whether a second communication device is roaming (step 401). If the process determines that the second communication device is not roaming, the process may proceed to step 411. If the process determines that the second communication device is roaming, the process may disable communication between the second communication device and the registration server (step 403).

The process may also determine whether the second, communication device is non-roaming (step 405). If the process determines that the second communication device is still roaming, the process may maintain disabled communication between the second communication device and the registration server (step 407). The process may then revert back to step 405. If the process determines that the second communication device is non-roaming, the process may re-establish communication with the registration server (step 409).

The process may then receive an electronic message, originated at a first communication device, over a first protocol (step 411). The electronic message may be received, at the second communication device. The process may then convert, at the second communication device, the electronic message to a second protocol (step 413). The process may then send the electronic message to a third communication device over the second protocol (step 415).

The process may also include receiving, at the second communication device, a reply electronic message from the third communication device (step 417). The reply electronic message may be responsive to the electronic message and be addressed to the first communication device. The process may then send the reply communication message to the first communication device (step 419). In step 419, the process may send the reply communication message to the first communication device via a registration server.

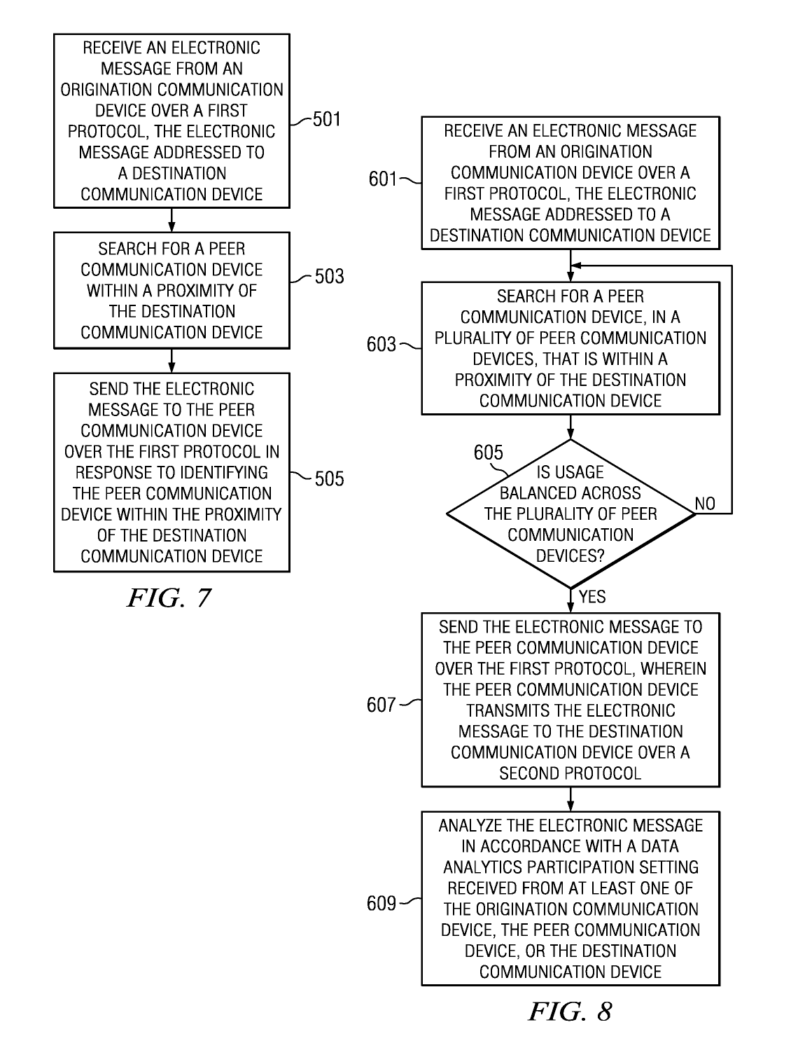

Referring to FIG. 7, an illustrative embodiment of a process for transmitting electronic messages in a peer-based messaging system, which may be implemented by, e.g., a registration server, includes receiving an electronic message from an origination communication device over a first protocol (step 501). The electronic message may be addressed to a destination communication device. The process may search for a peer communication device within a proximity of the destination communication device (step 503). The process may send the electronic message to the peer communication device over the first protocol in response to identifying the peer communication device within the proximity of the destination communication device (step 505).

Referring to FIG. 8, an illustrative embodiment of a process for transmitting electronic messages in the peer-based messaging system, which may be implemented by, e.g., a registration server, includes receiving an electronic message from an origination communication device over a first protocol (step 601). The electronic message may be addressed to a destination communication device. The process may include searching for a peer communication device, in a plurality of peer communication devices, that is within the proximity of the destination communication device (step 603).

The process may determine whether usage is balanced across the plurality of the peer communication devices (step 605). If the process determines that usage is not balanced across the plurality of peer communication devices, the process may return to step 603. If the process determines that usage is balanced across the plurality of peer communication devices, the process may send the electronic message to the identified peer communication device over the first protocol (step 607). The peer communication device may transmit the electronic message to the destination communication device over a second protocol. The process may then analyze the electronic message in accordance with a data analytics participation setting received from at least one of the origination communication device, the peer communication device, or the destination communication device (step 609).

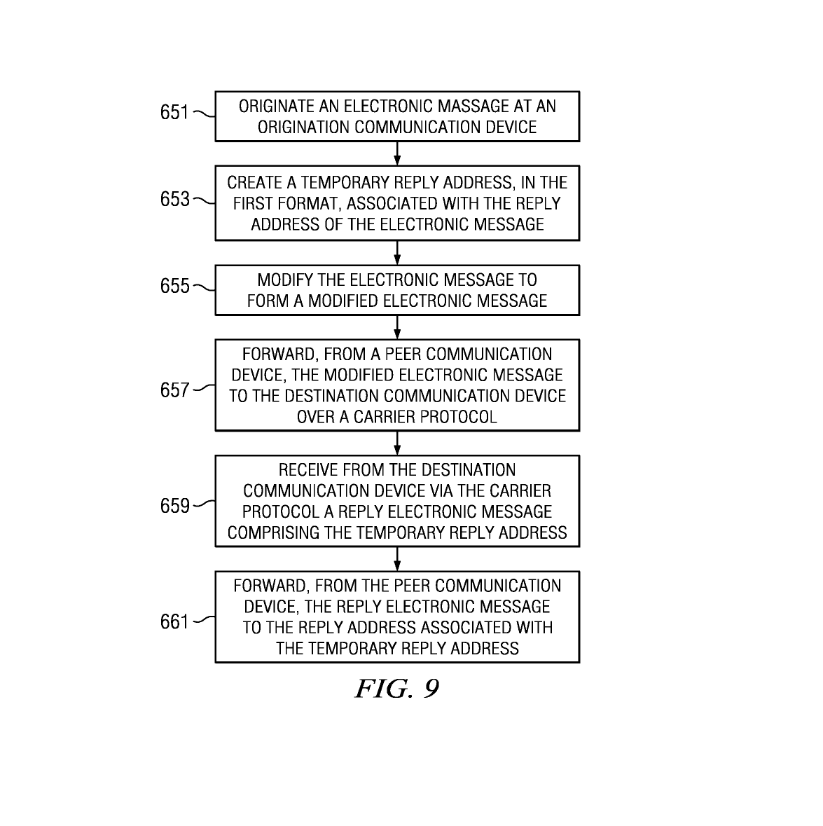

Referring to FIG. 9, an illustrative embodiment of a process for transmitting electronic messages in the peer-based messaging system includes originating an electronic message at an origination communication device (step 651). The electronic message may include a destination address, in a first format, associated with the destination communication device, and a reply address, in a second format, associated with an origination communication device. The process may include creating a temporary reply address, in the first format, associated with the reply address of the electronic message (step 653). The process may include modifying the electronic message to form a modified electronic message (step 655). The modified electronic message may include as a reply address the temporary reply address.

The process may include forwarding, from a peer communication device, the modified electronic message to the destination communication device over a carrier protocol (step 657). The process may include receiving from the destination communication device via a carrier protocol a reply electronic message comprising the temporary reply address (step 659). The reply electronic message may be received by the peer communication device. The process may also include forwarding, from the peer communication device, the reply electronic message to the reply address associated with the temporary reply address (step 661). The reply electronic message, in one embodiment, may be forwarded via a registration server.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

Referring to FIG. 10, a block diagran of a computing device 702 is shown in which the illustrative embodiments may be implemented. The computing device 702 may be the communication devices 102, 104, 106, 202, 204, 206, 302, 304, 306, 362, 364, 366, 368 described in FIGS. 1-4. In another embodiment, the electronic message management application 108, 208, 308 described in FIGS. 1-4 may be implemented on the computing device 702. In another embodiment, the computing device 702 may be the registration server 110, 210, 310 described in FIGS. 1-4. Computer-usable progran code or instructions implementing the processes used in the illustrative embodiments may be located on the computing device 702. The computing device 702 includes a communications fabric 703, which provides communications between a processor unit 705, a memory 707, a persistent storage 709, a communications unit 711, an input/output (I/O) unit 713, and a display 715.

The processor unit 705 serves to execute instructions for software that may be loaded into the memory 707. The processor unit 705 may be a set of one or more processors or may be a multi-processor core, depending on the particular implementation. Further, the processor unit 705 may be implemented using one or more heterogeneous processor systems in which a main processor is present with secondary processors on a single chip. As another illustrative example, the processor unit 705 may be a symmetric multi-processor system containing multiple processors of the same type.

The memory 707, in these examples, may be, for example, a random access memory or any other suitable volatile or non-volatile storage device. The persistent storage 709 may take various forms depending on the particular implementation. For example, the persistent storage 709 may contain one or more components or devices. For example, the persistent storage 709 may be a hard drive, a flash memory, a rewritable optical disk, a rewritable magnetic tape, or some combination of the above. The media used by the persistent storage 709 also may be removable. For example, a removable hard drive may be used for the persistent storage 709.

The communications unit 711, in these examples, provides for communications with other data processing systems or communication devices. In these examples, the communications unit 711 may be a network interface card. The communications unit 711 may provide communications through the use of either or both physical and wireless communication links.

The input/output unit 713 allows for the input and output of data with other devices that may be connected to the computing device 702. For example, the input/output unit 713 may provide a connection for user input through a keyboard and mouse. Further, the input/output unit 713 may send output to a processing device. In the case in which the computing device 702 is a cellular phone, the input/output unit 713 may also allow devices to be connected to the cellular phone, such as microphones, headsets, and controllers. The display 715 provides a mechanism to display information to a user, such as a graphical user interface.

Instructions for the operating system and applications or programs are located on the persistent storage 709. These instructions may be loaded into the memory 707 for execution by the processor unit 705. The processes of the different embodiments may be performed by the processor unit 705 using computer-implemented instructions, which may be located in a memory, such as the memory 707. These instructions are referred to as program code, computer-usable progran code, or computer-readable progran code that may be read and executed by a processor in the processor unit 705. The progran code in the different embodiments may be embodied on different physical or tangible computer-readable media, such as the memory 707 or the persistent storage 709.

Progran code 717 is located in a functional form on a computer-readable media 719 and may be loaded onto or transferred to the computing device 702 for execution by the processor unit 705. The progran code 717 and the computer-readable media 719 form computer progran product 721 in these examples. In one embodiment, the computer progran product 721 is the electronic message management application 108, 208, 308 described in FIGS. 1-4, respectively. In this embodiment, the progran code 717 may include computer-usable progran code capable of receiving an electronic message, originated at a first communication device, over a first protocol. The progran code 717 may also include computer-usable progran code capable of converting, at the second communication device, the electronic message to a second protocol. The first protocol may be different from the second protocol. The progran code 717 may also include computer-usable program code capable of sending the electronic message to a third communication device over the second protocol.

In another embodiment, the computer program product 721 may be implemented by the registration server 110, 210, 310 described in FIGS. 1-4. In this embodiment, the progran code 717 may also include computer-usable progran code capable of receiving an electronic message from an origination communication device over a first protocol. The electronic message may be addressed to a destination communication device. The progran code 717 may also include computer-usable progran code capable of searching for a peer communication device within a proximity of the destination communication device, and sending the electronic message to the peer communication device over the first protocol in response to identifying the peer communication device within the proximity of the destination communication device.

In another embodiment, the progran code 717 may also include computer-usable progran code capable of originating an electronic message at an origination communication device. The electronic message may include a destination address, in a first format, associated with a destination communication device, and a reply address, in a second format, associated with an origination communication device. The progran code 717 may also include computer-usable progran code capable of creating a temporary reply address, in the first format, associated with the reply address of the electronic message, and modifying the electronic message to form a modified electronic message. The modified electronic message may include as a reply address the temporary reply address. The progran code 717 may also include computer-usable progran code capable of forwarding, from a peer communication device, the modified electronic message to the destination communication device over a carrier protocol, and receiving from the destination communication device via the carrier protocol a reply electronic message comprising the temporary reply address. The reply electronic message may be received by the peer communication device. The progran code 717 may also include computer-usable progran code capable of forwarding, from the peer communication device, the reply electronic message to the reply address associated with the temporary reply address.

Any combination of the above-mentioned computer-usable progran code may be implemented in the progran code 717, and any functions of the illustrative embodiments may be implemented in the progran code 717.

In one example, the computer-readable media 719 may be in a tangible form, such as, for example, an optical or magnetic disc that is inserted or placed into a drive or other device that is part of the persistent storage 709 for transfer onto a storage device, such as a hard drive that is part of the persistent storage 709. In a tangible form, the computer-readable media 719 also may take the form of a persistent storage, such as a hard drive or a flash memory that is connected to the computing device 702. The tangible form of the computer-readable media 719 is also referred to as computer recordable storage media.

Alternatively, the progran code 717 may be transferred to the computing device 702 from the computer-readable media 719 through a communication link to the communications unit 711 or through a connection to the input/output unit 713. The communication link or the connection may be physical or wireless in the illustrative examples. The computer-readable media 719 also may take the form of non-tangible media, such as communication links or wireless transmissions containing the progran code 717. In one embodiment, the progran code 717 is delivered to the computing device 702 over the Internet.

The different components illustrated for the computing device 702 are not meant to provide architectural limitations to the manner in which different embodiments may be implemented. The different illustrative embodiments may be implemented in a data processing system including components in addition to or in place of those illustrated, for computing device 702. Other components shown in FIG. 10 can be varied from the illustrative examples shown.

As one example, a storage device in the computing device 702 is any hardware apparatus that may store data. The memory 707, the persistent storage 709, and the computer-readable media 719 are examples of storage devices in a tangible form.

In another example, a bus system may be used to implement the communications fabric 703 and may be comprised of one or more buses, such, as a system bus or an input/output bus. Of course, the bus system may be implemented using any suitable type of architecture that provides for a transfer of data between different components or devices attached to the bus system. Additionally, the communications unit 711 may include one or more devices used to transmit and receive data, such as a modem or a network adapter. Further, a memory may be, for example, the memory 707 or a cache such as found in an interface and memory controller hub that may be present in the communications fabric 703.

As used, herein, including in the claims, the terms first, second, third, etc . . . used in relation to an element (e.g., first communication device, second communication device, etc.) are for reference or identification purposes only, and these terms, unless otherwise indicated, are not intended to describe or suggest a number, order, source, purpose, or substantive quality for any element for which such a term is used.

Although the illustrative embodiments described, herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A method for transmitting electronic messages, the method comprising:
receiving an electronic message, originated at a first communication device, over a first protocol, the electronic message received at a second communication device;
converting, at the second communication device, the electronic message to a second protocol, the first protocol different from the second protocol; and
sending the electronic message to a third communication device over the second protocol.

2. The method of claim 1, wherein the second communication device is associated with a user;
wherein the electronic message is addressed for transmission to the third communication device; and
wherein the second communication device refrains from notifying the user when the second communication device receives the electronic message.

3. The method of claim 1, wherein the electronic message is a Short Message Service (SMS) message.

4. The method of claim 1, wherein the first protocol is a Transmission Control Protocol/Internet Protocol (TCP/IP) protocol; and
wherein the second protocol is a carrier protocol.

5. The method of claim 1, wherein the electronic message is a Short Message Service (SMS) message;
wherein the first protocol is a Transmission Control Protocol/Internet Protocol (TCP/IP) protocol; and
wherein the second protocol is a carrier protocol usable for transmission of SMS messages.

6. The method of claim 1, wherein receiving the electronic message, originated at the first communication device, over the first protocol comprises receiving the electronic message from the first communication device via a registration server.

7. The method of claim 6, further comprising:
detecting whether the second communication device is roaming; and
disabling communication between the second communication device and the registration server in response to determining that the second communication device is roaming.

8. The method of claim 7, further comprising:
re-establishing communication with the registration server in response to determining that the second communication device is non-roaming.

9. The method of claim 1, wherein the method is implemented by an electronic message management application on the second communication device.

10. The method of claim 1, further comprising:
receiving, at the second communication device, a reply-electronic message from the third communication device, the reply electronic message responsive to the electronic message and addressed to the first communication device; and
sending the reply communication message to the first communication device.

11. The method of claim 10, wherein sending the reply communication message to the first communication device comprising sending the reply communication message to the first communication device via a registration server.

12. The method of claim 10, wherein the reply electronic message is received at the second communication device over the second protocol; and
wherein the reply communication message is sent to the first communication device over the first protocol.

13. The method of claim 1, further comprising:
receiving a set of user settings from a user associated with the second communication device, the set of user settings comprising at least one of a data cap, a message cap, or a data analytics participation setting; and
sending the set of user settings to a registration server.

14. A method for transmitting electronic messages, the method comprising:
receiving an electronic message from an origination communication device over a first protocol, the electronic message addressed to a destination communication device;
searching for a peer communication device -within a proximity of the destination communication device; and
sending the electronic message to the peer communication device over the first protocol in response to identifying the peer communication device within the proximity of the destination communication device.

15. The method of claim. 14, wherein the peer communication device transmits the electronic message to the destination communication device over a second protocol, the first protocol different from the second protocol.

16. The method of claim 14, wherein the peer communication device is one of a plurality of peer communication devices used to dispatch electronic messages to destination communication devices, the method further comprising:
balancing usage across the plurality of peer communication devices based on at least one of an availability to deliver to a region associated with the destination communication device, data caps associated with each of the plurality of peer communication devices, message caps associated with each of the plurality of peer communication devices, a routing cost for routing the electronic message, roaming statuses of each of the plurality of peer communication devices, or an electronic message throughput associated with each of the plurality of peer communication devices.

17. The method of claim 14, further comprising:
analyzing the electronic message using rules-based weighting based upon incidences of keywords in the electronic message.

18. The method of claim 14, further comprising:
receiving a data analytics participation setting from at least, one of the origination communication device, the peer communication device, or the destination communication device, wherein the data analytics participation setting is one of an opt-out setting, an opt-in setting, or an anonymous opt-in setting; and
analyzing the electronic message in accordance with the data analytics participation setting.

19. A peer-based messaging system comprising:
an electronic message management application executable on a peer communication device, the electronic message management application to receive electronic messages, originated at one or more origination communication devices, over an internet-based protocol, convert the electronic messages to a short message service (SMS) carrier protocol, and send the electronic messages to one or more destination communication devices over the SMS carrier protocol.

20. The peer-based messaging system of claim 19, further comprising:
a registration server in communication with the one or more origination communication device and the peer communication device, the registration server comprising:
a credit tracking module to manage allocation of credits to an account associated with the peer communication device based on electronic messages sent to the peer communication device.

21. The peer-based messaging system of claim 19, further comprising:
a registration server in communication with the origination communication device and the peer communication device, the registration server comprising:
a load balancing module to determine the peer communication device through which to transmit, the electronic messages based on at least one of an availability to deliver to a region associated with the destination communication device, data caps associated with each of the plurality of peer communication devices, message caps associated with each of the plurality of peer communication devices, a routing cost for routing the electronic message, roaming statuses of each of the plurality of peer communication devices, or an electronic message throughput associated with each of the plurality of peer communication devices.

22. The peer-based messaging system of claim 19, further comprising:
a registration server in communication with the one or more origination communication devices and the peer communication device, the registration server comprising:
a data analytics module to analyze content of the electronic messages.

23. The peer-based messaging system of claim 19, further comprising:
a pool of peer communication devices, each of the peer communication devices in the pool of peer communication devices executing a respective electronic message management application, the pool of peer communication devices tracking-multiple unique electronic conversations that include the origination communication device.

24. The peer-based messaging system of claim 19, further comprising:
a registration server in communication with the one or more origination communication devices and the peer communication device; and
a pool of peer communication devices, each of the peer communication devices in the pool of peer communication devices executing a respective electronic message management application and each of the peer communication devices in the pool of peer communication devices registered to the registration server.

25. A peer-based messaging system comprising:
a destination communication device;
an origination communication device to originate an electronic message, the electronic message comprising:
a destination address, in a first format, associated. with the destination communication device; and
a reply address, in a second format, associated with the origination communication device; and
one or more devices comprising a pool of peer communication devices, each of the pool of peer communication devices comprising an electronic message management application, the one or more devices to (a) receive the electronic message from the origination communication device over a first protocol, (b) create a temporary reply address, in the first format, associated with the reply address of the electronic message, (c) modify the electronic message to form a modified electronic message, the modified electronic message including as a reply address the temporary reply address, (d) forward the modified electronic message to the destination communication device over a second protocol, the second protocol different from the first protocol, (e) receive from the destination communication device, via the second protocol, a reply electronic message including the temporary reply address, and (f) forward the reply electronic message to the origination communication device whose reply address is associated with the temporary reply address.

26. The peer-based messaging system of claim 25, wherein the first format corresponds to a mobile phone number.

27. The peer-based messaging system of claim 25, wherein the second format corresponds to an Internet address.

28. The peer-based messaging system of claim 25, wherein the one or more devices includes a registration server.

29. The peer-based messaging system of claim 25, wherein a number of peer communication devices in the pool of peer communication devices is determined based on roaming-statuses of each of the peer communication devices such that (a) a particular peer communication device is included in the pool of peer communication devices if the peer communication device is non-roaming, and (b) the particular peer communication device is excluded from the pool of peer communication devices if the peer communication device is roaming.

30. A method for transmitting electronic messages, the method comprising:
originating an electronic message at an origination communication device, the electronic message comprising:
a destination address, in a first format, associated with a destination communication device; and
a reply address, in a second format, associated with an origination communication device;
creating a temporary reply address, in the first format, associated with the reply address of the electronic message;
modifying the electronic message to form a modified electronic message, the modified electronic message including as a reply address the temporary reply address;
forwarding, from a peer communication device, the modified electronic message to the destination communication device over a carrier protocol;
receiving from the destination communication device via the carrier protocol a reply electronic message comprising the temporary reply address, the reply electronic message received by the peer communication device; and
forwarding, from the peer communication device, the reply electronic message to the reply address associated with the temporary reply address.

31. The method of claim 30, wherein the first format corresponds to a mobile phone number.

32. The method of claim 30, wherein the second format corresponds to an Internet address.

33. The method of claim 30, wherein the reply electronic message is forwarded to the reply address associated with the temporary reply address via a registration server.

34. The method of claim 30, wherein the temporary reply address is created by one of the peer communication devices or a registration server.
